(19) United States
(12) Patent Application Publication
(10) Pub. No.: US 2026/0240212 A1
(43) Pub. Date: Aug. 20, 2026

(54) HOLLOW SNACK PRODUCT AND PROCESS FOR PREPARATION THEREOF

(71) Applicant: Remind Foods Pvt. Ltd., Bangalore, Karnataka (IN)

(72) Inventors: Rohan Ivan, Ernakulam (IN); Vani Ahuja, Jaipur (IN)

(73) Assignee: Remind Foods Pvt. Ltd., Bangalore, Karnataka (IN)

(21) Appl. No.: 19/157,669

(22) PCT Filed: Mar. 12, 2024
(86) PCT No.: PCT/IB2024/052370

§ 371 Date: Aug. 18, 2025

(30) Foreign Application Priority Data
Mar. 12, 2023 (IN) 202241071681

(51) Int. Cl. A23L 29/212; A23L 5/10; A23L 7/117; A23L 19/00; A23L 19/12; A23P 30/00

(52) U.S. Cl. CPC A23L 29/212; A23L 5/10; A23L 7/117; A23L 19/09; A23L 19/13; A23P 30/00

(57) ABSTRACT

Disclosed is a hollow snack product and a process (100) for preparation thereof. The hollow snack product has crispy-crunchy texture and is nutritious, zero-added oil product having consumer-desired organoleptic properties comparable to fried snack counterparts. The process is versatile, uses wide range of base ingredients to form the hollow snack product into any desired shape. The process is economical and can be carried out on commercial scale to prepare uniformly textured snack crisp comparable to the sensory characteristics of fried potato snack chips and crisps available in the market.

### CROSS-REFERENCE TO RELATED PATENT APPLICATIONS

This application is a national stage entry of PCT/IB2024/052370, filed on Mar. 12, 2024, which claims priority to Indian Patent Application number 202241071681, filed on Mar. 12, 2023, each of which is incorporated herein by reference in its entirety.

### FIELD

The present disclosure relates to snack products. More particularly, the present disclosure relates to a hollow snack product and process for preparation thereof.

### BACKGROUND

Conventional snack products including snack crisps or chips available in the market globally are made by frying or extrusion technology. The frying leads to high intake of oil during processing thereby creating unhealthy snack products.

Numerous attempts have been made in the prior art to reduce oil content and create healthier alternatives of the conventionally available snack products. The healthier alternatives are made using methods such as baking, dehydration, vacuum frying, popping, roasting, freeze drying, etc. However, the products made from these technologies pose the following challenges to the customers such as uneven and hard texture, inferior crispiness, crunchiness etc. Further, most of the healthiest options available are not economically priced and have limited customer acceptance due to unsatisfactory sensory attributes of the product. Furthermore, the healthier alternatives prepared using existing technologies result in snack products having organoleptic properties which are far less desirable than their fried snack counterparts. Furthermore, existing technologies while using high starchy starting material such as potato flour or corn flour to prepare snack products, for example, potato chips requires addition of gluten to form a machinable dough. A hydrated starch or gelatinous composition (for example, potato flour when mixed with water) without gluten typically does not form a dough that is “workable” or machinable or sheetable. Hence, the snack foods produced from starchy materials must be extruded to form a final product or mixed with gluten-containing flour to form a dough that can be machined and baked into a final product. Therefore, for making snack products, usually a mixture with a high starch and high moisture content is avoided as it creates a very sticky, not workable, machinable dough when the temperatures go above 50-60 degrees. Existing solution to address this shortcoming and achieve a dough that can be sheeted, is to partially gelatinize the starch along with a moisture content of less than 60%, and by using additives such as emulsifiers, hydrolysed starches, modified starches, starch hydrolysis products etc.

Thus, many health-conscious consumers desire for healthier and natural alternatives to the conventional snack crips without addition of any additives but with minimal taste differences from their fried snack counterparts.

Therefore, there is a need to provide a solution that can provide a way to make the mixture made from gelatinizing high starch and water workable without using additives. There exists a need for providing healthier alternatives of the conventional snack products. Particularly, there is a need to provide healthier alternatives having desirable organoleptic properties such as texture, taste, mouthfeel etc. which are similar to conventional fried-snack products or an improvement in an organoleptic property as compared to their conventional snack counterparts. There is a need to provide healthier snack products that mimics the taste and texture of fried snack products.

There exists a need for a versatile technology that can create products that improve or eliminate the limitations of the existing technologies, where the technology also enables the use of various ingredients as base material to create a healthy snack product. There is a need for a process that can incorporate use of a wide range of naturally sourced vegetables and fruits to create the snack product offering far more nutritional benefits than their conventional fried counterparts whist maintaining similar crispy, crunchy texture as desired by the consumers for snack products.

### OBJECTS

It is an object of the present disclosure to provide a hollow snack product.

It is another object of the present disclosure to provide a process for preparation of the hollow snack product.

It is yet another object of the present disclosure to provide the process for preparation of the hollow snack product having desirable organoleptic properties comparable to their conventional fried counterparts.

It is yet another object of the present disclosure to provide the process for preparation of a healthy, nutritious, zero-added oil, hollow, crisp and crunchy snack product that utilizes wide range of naturally sourced base ingredients and can be suitably carried out on a commercial scale.

It is yet another object of the present disclosure to provide a crispy, hollow & uniformly textured snack crisp comparable to the sensory characteristics of fried potato snack chips and crisps available in the market.

It is yet another object of the present disclosure to provide a mid-meal snack which contains healthy proportion of macronutrients such as carbohydrates, protein, dietary fiber & fat.

It is yet another object of the present disclosure to provide a versatile technology that can be applied across a wide range of base materials with absolute control on oil and nutrition content as desired by the consumer.

### SUMMARY

The present disclosure provides a process for preparation of a hollow snack product. The process includes admixing at least one base ingredient with at least one native starch and water to obtain a homogeneous mixture. Particularly, the base ingredient, the native starch and the water is mixed in a pre-determined quantity such that a total quantity of starch content and starch:water ratio is maintained at pre-defined values being in the range of 14-18% by weight and 1:4 to 1:5.5 respectively within the homogeneous mixture. Optionally, if the base ingredient has high content/amount of the starch, then the process excludes a step of adding the native starch to the base ingredient to adjust to their pre-defined values of the starch content being in the range of 14-18% by weight. Optionally, if the base ingredient has high water content such that the starch:water ratio gets maintained at their pre-defined values in the range of 1:4 to 1:5.5, then the process excludes a step of adding water. The base ingredient is in any one form selected from a raw/unprocessed and processed, and further comprises of at least one selected from a group consisting of vegetables, fruits, millets, legumes, cereals, nuts, grains, pulses, beans, seeds and combinations thereof. Optionally, in an event the base ingredient is raw, the process includes an additional processing step, comprising of a cooking and grinding stage to obtain the base ingredient in form of a puree, wherein, starch within the base ingredient undergoes gelatinization during the cooking stage. The native starch is at least one selected from a group consisting of potato starch, tapioca starch, corn starch, rice starch, bean starch and combinations thereof. Optionally, the process may include an additional step of adding at least one ingredient selected from a group consisting of protein(s), protein isolate(s), protein concentrate(s), edible soluble fiber(s), edible insoluble fiber(s) such as citrus, wheat, oat fiber and combinations thereof, to the homogeneous mixture to enhance nutritional profile of the hollow snack product.

The process thereafter includes subjecting the homogenous mixture to a gelatinization temperature in the range of 60-90° C. followed by cooling thereof to obtain a gelatinized mixture. During this step, the total quantity of starch, including the native starch and the starch content present within the base ingredient, undergoes gelatinization to form the gelatinized mixture having gelatinized starch therewithin. Optionally, in an event if the native starch is not added to the base ingredient, the process excludes this step of gelatinization.

The process thereafter includes mechanically aerating the gelatinized mixture uniformly using a mechanically aerating apparatus for a time period ranging from 30-120 sec. During the mechanical aeration step, air entraps within the gelatinized starch to provide an aerated mixture, the viscosity of which lies in the range of 15,000 to 50,000 cp. The mechanical aerating apparatus is selected from a group consisting of a continuous mixer, food processor with dough blade, thermomix, mixing bowl with a whipping blade and a single stone and double stone grinder. Optionally, the process may include an additional step of adding at least one ingredient selected from a group consisting of oil, salt, sugar, yeast, flavouring agent, colouring agent, seasoning(s), spice(s), herb(s), vitamin(s), and combinations thereof to the aerated mixture to enhance organoleptic properties of end product i.e., the hollow snack product.

The process thereafter includes forming the aerated mixture using a piping apparatus into at least one cylindrical shape followed by cutting thereof to obtain a plurality of formed cylindrical pieces. Each piece of the plurality of formed cylindrical pieces have a shape corresponding to the at least one cylindrical shape, and a diameter and length in the range of 5-15 mm and 20-100 mm respectively. The piping apparatus includes any one of manual and automated piping apparatus, and is at least one selected from a group consisting of a cookie drop wire cut machine, a volumetric doser and a piping bag. The at least one cylindrical shape is selected from a group consisting of a cylinder, a cylindrical curl, a cylindrical ring, a cylindrical S-shaped curve and combinations thereof.

The process thereafter includes subjecting the plurality of formed cylindrical pieces to a 2-stage drying process using at least one dryer. The at least one dryer selected from a group consisting of a conventional oven, convection oven, hot air dryer, multi-layer dryer, a vacuum dryer, a gas fired rotary oven and combinations thereof. The 2-stage drying process includes the following steps:
In a stage-1 drying process, the formed cylindrical pieces are initially exposed to a temperature in the range of 100 to 160° C. until water converts into steam and expands along with expansion of entrapped air to exert an outward force from center of the formed cylindrical pieces while the gelatinized starch prevents escape of the air therefrom and therethrough thereby increasing size of the formed cylindrical pieces along with formation of a hollow structure with closed ends.
In stage-2 drying process, the formed cylindrical pieces having undergone stage-1 drying process are further exposed to a temperature in the range of 100 to 180° C. until the moisture reduces to 1-5% by weight to cause dehydration thereby leading to formation of the hollow snack product with closed ends. The hollow snack product thus obtained is in form of a horseshoe tunnel with closed ends having shape corresponding to shape of the formed cylindrical pieces and has a rigid structure, crispy and crunchy texture and an Overall Acceptability Score of at least 7.5. In an alternative embodiment, the hollow snack product is obtained in form of a cylindrical tunnel with closed ends having shape corresponding to shape of the formed cylindrical pieces.

Accordingly, the hollow snack product prepared using the afore-mentioned process has a crispy, crunchy texture, and contains 30-100% by weight of the base ingredient, has a moisture content in the range of 1-5% by weight, bulk density in range of 0.15 g/cc-0.3 g/cc, and dimensions having Length (L) in the range of 20-100 mm, Breadth (B) in the range of 6-18 mm and Height (H) in the range of 6-18 mm. The hollow snack product has an Overall Acceptability Score of at least 7.5 and is in form of a horseshoe tunnel with closed ends having at least one cylindrical shape selected from a group consisting of a cylinder, a cylindrical curl, a cylindrical ring, a cylindrical S-shaped curve and combinations thereof. In an alternative embodiment, the hollow snack product is obtained in the form of a cylindrical tunnel with closed ends having at least one cylindrical shape and diameter in the range of 6-18 mm, wherein the at least one cylindrical shape is selected from a group consisting of a cylinder, a cylindrical curl, a cylindrical ring, a cylindrical S-shaped curve and combinations thereof.

The hollow snack product contains the base ingredient in any one form selected from a raw/unprocessed and processed, and further comprises of at least one selected from a group consisting of vegetables, fruits, millets, legumes, cereals, nuts, grains, pulses, beans, seeds and combinations thereof. However, it is evident to a person skilled in the art that any type of vegetable, fruits, legumes, cereals, nuts and seeds known in the art can be used as the base ingredient either in their processed or unprocessed forms.

Optionally, the hollow snack product contains at least one native starch selected from a group consisting of potato starch, tapioca starch, corn starch, rice starch, bean starch and combinations thereof. In an embodiment, the quantity of the native starch depends upon the starch content of the base ingredient. Optionally, the hollow snack product contains at least one ingredient selected from a group consisting of protein(s), protein isolate(s), protein concentrate(s), edible soluble fibre(s), edible insoluble fibre(s), oil, salt, sugar, yeast, flavouring agent, colouring agent, seasoning(s), spice(s), herb(s), vitamin(s) and combinations thereof to enhance nutritional profile and organoleptic properties of the hollow snack product.

Therefore, in contradistinction to the existing solutions, the process of present disclosure facilitates in offering the hollow snack product that is healthier and whilst has organoleptic properties comparable to their conventional fried counterparts.

### BRIEF DESCRIPTION OF THE ACCOMPANYING DRAWINGS

The present disclosure is illustrated in the accompanying non-limiting drawings, throughout which reference letters indicate corresponding parts in the various figures.

FIG. 1 illustrates a flow-chart of a process for preparation of a hollow snack product, in accordance with the present disclosure;

FIG. 2-5, shows four different example embodiments of the process disclosed in FIG. 1, in accordance with alternate embodiments of the present disclosure;

FIG. 6 shows images of the end product of example 1, example 2 and example 3, made in accordance with example embodiments of the present disclosure;

FIG. 7 shows images of the end product of example 6 and example 7 along with SEM image thereof, made in accordance with example embodiments of the present disclosure;

FIG. 8 shows images of the end product of example 11, example 13, and example 16, made in accordance with example embodiments of the present disclosure;

FIG. 9 shows images of the end product of example 17, example 20 and example 21, made in accordance with example embodiments of the present disclosure;

FIG. 10 shows images of the end product of example 22 and example 23, made in accordance with example embodiments of the present disclosure;

FIG. 11 shows images of the end product of example 24 and example 26 along with SEM images thereof, made in accordance with example embodiments of the present disclosure;

FIG. 12 shows images of the end product of example 27 and example 28, made in accordance with example embodiments of the present disclosure; and

FIG. 13 shows images of the end product of example 29, made in accordance with example embodiments of the present disclosure.

### DETAILED DESCRIPTION

The present disclosure provides a hollow snack product and a process for preparation thereof. The hollow snack product is uniformly textured, highly nutritious, zero-added oil, crisp and crunchy snack product having organoleptic properties comparable to that of their fried counterparts available in market. The process is versatile and can be applied across wide range of naturally sourced ingredients such as vegetables and fruits to prepare the hollow snack product having consumer-desired organoleptic properties, thereby making it more economical to carry out on a commercial scale.

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. As used herein, the term “and/or” includes any and all combinations of one or more of the associated listed items. Expressions such as “at least one of,” when preceding a list of elements, modify the entire list of elements and do not modify the individual elements of the list. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

This present invention is illustrated with reference to the accompanying drawings, throughout which reference numbers/labels indicate corresponding parts in the various figures. These reference numbers are shown in bracket in the following description.

In accordance with one aspect of the present disclosure, a process (100), hereinafter referred to as “the process (100) for preparation of a hollow snack product is disclosed. The process (100) is versatile that can be applied across wide range of naturally sourced ingredients and is thus economical to carry out on a commercial scale.

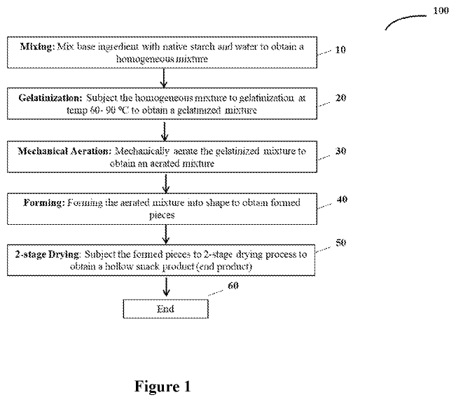

Accordingly, referring to FIG. 1, the process (100), at step (10), includes admixing at least one base ingredient with at least one native starch and water to obtain a homogeneous mixture. Particularly, a pre-determined quantity of the at least one base ingredient (hereinafter referred to as “the base ingredient”), the at least one native starch (hereinafter referred to as “the native starch”) and water is mixed such that a total quantity of starch content and starch:water ratio is maintained at pre-defined values thereof within the homogeneous mixture. More particularly, the pre-defined values for the starch content and the starch:water ratio is in the range of 14-18% by weight and 1:4 to 1:5.5 respectively. The afore-mentioned numerical ranges form the crux of the present disclosure and are a characterizing feature. Here, the term ‘total quantity’ refers to a combined quantity, such that the total quantity of starch is a combined quantity of the native starch and the starch present within the base ingredient. Similarly, the total quantity of water a combined quantity of water present within the base ingredient and water added within the homogeneous mixture. Specifically, the homogeneous mixture contains the pre-determined quantity of the base ingredient, the native starch and the water, wherein, the pre-determined quantity is calculated such that the total quantity of starch content and starch:water ratio is maintained at the pre-defined values thereof being in the range of 14-18% by weight and 1:4 to 1:5.5 respectively within the homogeneous mixture. In an alternate embodiment, if the base ingredient contains high starch content such that the pre-defined value thereof gets maintained between 14-18% by weight, then the native starch is not required to be added at step (10). In another alternate embodiment, if the base ingredient contains high water content, such that the pre-defined value of the starch to water ratio gets maintained between 1:4 to 1:5.5, then water is not required to be added at step (10).

The base ingredient is in any one form selected from a raw/unprocessed and processed. The base ingredient comprises of at least one selected from a group consisting of, but not limited thereto, vegetables, fruits, millets, legumes, cereals, nuts, grains, pulses, beans, seeds and like, or combinations thereof. The vegetables and fruits may be used in unprocessed form such as whole vegetable/fruit or in processed forms such as, not limiting to, puree/paste, concentrate, powder/flour, dehydrated form, juice, flakes and like, or combinations thereof.

In an embodiment, the vegetables may include any one of, but not limited thereto, carrot, beetroot, capsicum (also known as a pepper), cabbage, tomato, peas, broad beans, cabbage, aubergine, potato, yam, sweet potato, sweetcorn, broccoli, spinach; a cucurbit vegetable, such as squash (for example, butternut squash), pumpkin, cucumber, cauliflower, celeriac, celery, courgette or marrow; an allium vegetable (for example, onion, garlic, shallot, chive or scallion), herbs or flavourants (for example, thyme, basil, oregano, parsley, chilli or dill), and like or combinations thereof. In another embodiment, the fruits may include any one of, but not limited thereto, apple, pear, orange, strawberries, jackfruit, blackberries, raspberries, banana, blackcurrants, blueberries, cranberries, persimmon, plum, peach, apricot, orange, mandarin, lemon, grapefruit, lime, mango, cherry, pineapple, kiwi, fig, papaya, guava, pomegranate, grape and like, or combinations thereof. In yet another embodiment, the legumes may be used in unprocessed form such as grains or in processed form such as flour, and may include any one of, but not limited thereto, beans, lentils, pulses, peas and like, or combinations thereof. In yet another embodiment, the cereals may be used in unprocessed form such as grains or in processed form such as flour, and may include any one of, but not limited thereto, rice, maize, oat, wheat, barley, sorghum, quinoa, millets and like, or combinations thereof. In yet another embodiment, the nuts may be used in unprocessed form such as whole nuts or in processed form such as nut flour, and may include any one of, but not limited thereto, almonds, pistachio, hazelnuts, peanuts, walnuts, cashew, brazil or pine nuts, and like, or combinations thereof. In yet another embodiment, the seeds may be used in unprocessed form such as whole seeds or in processed form such as seed flours and may include any one of, but not limited thereto, sunflower seeds, sesame seeds, pumpkin seeds, flax seeds, chia seeds and like, or combinations thereof. However, it is evident to a person skilled in the art, that of any other type of vegetable, fruit, legumes, cereals, nuts and seeds not specifically enlisted hereinabove but known in the art may be used.

In an embodiment, if the base ingredient used is raw, then the process (100) additionally includes a processing step for size reduction prior to step (10). The processing step of the base ingredient comprises of a cooking stage followed by a grinding stage to obtain the base ingredient in form of a puree wherein, the starch present within the base ingredient undergoes gelatinization during the cooking stage. The cooking stage is performed using any of existing methods including, but not limited thereto, steaming, blanching pressure cooking, boiling and like, or combinations thereof. The grinding stage is performed using any existing methods known in the art.

The native starch is at least one selected from a group consisting of, but not limited thereto, potato starch, tapioca starch, corn starch, rice starch, bean starch and like, or combinations thereof. As known in the art, the native starch is basically pure form of starch obtained from sources such as, corn, wheat, potato, rice, cassava and tapioca and like. The native starch is a long-chain carbohydrate insoluble in cold water and swell to different degrees, depending on type and temperature. However, due to their limitations such as breaking down of the native starch when reheated or when exposed to acidic environment etc., some food manufacturers have moved to using food starches which have been physically, chemically or enzymatically modified. The present disclosure however, addresses this concern by providing the process (100) that uses the native starch to create the hollow snack product having similar properties comparable to their fried counterparts.

In an alternate embodiment, the process (100) optionally includes adding at least one ingredient selected from a group consisting of, but not limited thereto, protein(s), protein isolate(s), protein concentrate(s), edible soluble fiber(s), edible insoluble fiber(s) such as citrus, wheat, oat fiber and like, or combinations thereof, to the homogeneous mixture of step (10) to enhance nutritional profile of end product, i.e. the hollow snack product.

The process (100), at step (20), includes subjecting the homogenous mixture of step (10) to a gelatinization by exposing to a gelatinization temperature in the range of 60-90° C., and followed by cooling thereof to obtain a gelatinized mixture. The gelatinization temperature is the temperature that initiates gelatinization of the starch, and thus depends on type of the starch used and varies accordingly. The gelatinization temperature depends upon the amount of water available for reaction with the starch. The lower the amount of available water, generally, the higher the gelatinization temperature. If the starch is separated and added to the formulation, then generally a w/s ratio of about 1.5:1 would be required for complete gelatinization (60% moisture, wet basis), and a ratio of 0.3:1 (about 25% moisture, wet basis) would be required for any gelatinization.

Particularly, the homogeneous mixture is exposed to the gelatinization temperature of the native starch present therewithin. During this step, the total quantity of the starch undergoes gelatinization. The gelatinized mixture thus obtained is in form of thick and viscous mixture containing gelatinized starch there within. In an alternate embodiment, if the native starch is not added at step (10), then the process excludes this step of gelatinization. The gelatinized mixture is not workable or machinable or sheetable.

The process (100), at step (30), includes mechanically aerating the gelatinized mixture uniformly to obtain an aerated mixture. The gelatinized mixture is mechanically aerated using a mechanically aerating apparatus for a time period ranging from 30-120 sec, such that air entraps within the gelatinized starch of the gelatinized mixture to provide an aerated mixture. Specifically, the gelatinized mixture is thick viscous mixture, and aeration allows incorporation of air bubbles resulting into the aerated mixture which is a lighter, less dense and fluffy mixture having viscosity that is suitable to form (or piped) into shape. Particularly, the aeration step establishes the aerated mixture which is workable and can be used for forming into shapes. Mechanical aeration forms a characterising feature of the present disclosure. The process (100) of the present disclosure thus facilitates in converting ‘non-workable (non-sheetable)’ mixture into a ‘workable’ mixture without use of any additives or gluten, as opposed to the existing prior art solutions. The aerated mixture has viscosity in range of 15,000 to 50,000 cp and is capable of forming. The viscosity range is a characterising feature of the present disclosure. The gelatinized mixture is thick and viscous which is mechanically aerated to obtain the aerated mixture which is in form of a light and airy mixture. The mechanical aerating apparatus is selected from a group consisting of, but not limited thereto, continuous mixer, food processor with dough blade, thermomix, mixing bowl with a whipping blade, single stone and double stone grinder and like, or combinations thereof. In an alternate embodiment, the process (100) optionally includes adding at least one ingredient selected from a group consisting of, but not limited thereto, oil, salt, sugar, yeast, flavouring agent, colouring agent, seasoning(s), spice(s), herb(s), vitamin(s), and like, or combinations thereof, to the aerated mixture of step (30) and homogeneously mixing, to enhance organoleptic properties of the end product, i.e. the hollow snack product.

The process (100), at step (40), includes forming the aerated mixture into at least one cylindrical shape using a piping apparatus. The piping apparatus includes any one of manual and automated piping apparatus, and is at least one selected from a group consisting of, but not limited thereto, a cookie drop wire cut machine, a volumetric doser, a piping bag and like. The at least one cylindrical shape is selected from a group consisting of, but not limited thereto, a cylinder, a cylindrical curl, a cylindrical ring, a cylindrical S-shaped curve and like, or combinations thereof. Thereafter, the process (100) includes cutting the at least one cylindrical shape lengthwise into plurality of formed cylindrical piece(s), each having diameter and length in the range of 5-15 mm and 20-100 mm respectively. The plurality of formed cylindrical pieces (hereinafter referred to as “the formed cylindrical piece(s)”), has a shape corresponding to the at least one cylindrical shape from which they were obtained. The step of piping into a cylindrical shape also forms a characterising feature of the present disclosure.

The process (100), at step (50), includes subjecting the plurality of formed cylindrical piece(s) to a 2-stage drying process using at least one dryer. The at least one dryer selected from a group consisting of, but not limited thereto, a conventional oven, convection oven, hot air dryer, multi-layer dryer, a vacuum dryer, a gas fired rotary oven and like, or combinations thereof. The 2-stage drying process includes the following steps:

In a stage-1 drying process, the formed cylindrical piece(s) is initially exposed to a temperature in the range of 100 to 160° C. in the dryer. Heating causes conversion of water present within the formed cylindrical piece(s) into steam, and expansion thereafter. In addition, heating causes expansion of air entrapped within the gelatinized starch of the formed cylindrical piece(s). This expansion of air and steam is a volumetric expansion. This expansion of air along with the steam generated, thereafter collaboratively exerts an outward force away from centre of the formed cylindrical piece(s). As heated air and steam tries to escape from the formed cylindrical pieces, the gelatinized starch gets concentrated on wall of the formed cylindrical pieces and prevents escape therefrom and therethrough thereby resulting in stretching of and increase in size of the formed cylindrical pieces along with leading to formation of a hollow structure with closed ends. The gelatinized starch of the formed cylindrical pieces is primarily responsible for dense non-porous wall formation towards the end of the stage-1 drying process. The formation of a dense non-porous wall is a characterising feature of the present disclosure.

The stage-1 drying process is followed by a stage-2 drying process. In stage-2 drying process, the formed cylindrical piece(s) having hollow structure with closed ends formed at the end of stage-1 drying process, is thereafter exposed to a temperature in the range of 100 to 180° C. to cause dehydration. Specifically, the stage-2 drying process is continued till moisture content reduces to 1-5% by weight thereby leading to formation of a rigid hollow structure with closed ends. In an alternate embodiment, protein and fibre if optionally added during the process (100) helps increase nutritional content/profile of the end product. In another alternate embodiment, if yeast is optionally added during the process (100), it activates at its suitable activation temperature and will feed on sugars within the formed cylindrical pieces to produce CO2 gas which expands and will further exert outward force thereby resulting in formation of the end product with larger overall size than that without yeast. Here, size of the end product may be controlled by factors such as the quantity of yeast in the formulation, degree of aeration, recipe formulation and time temperature combinations of drying. At the end of stage-2 drying process, the hollow snack product having crispy and crunchy texture is thus obtained. The hollow snack product(s) obtained has an Overall Acceptability Score of at least 7.5, and is in form of a horseshoe tunnel with closed ends having corresponding to shape of the formed cylindrical piece(s). In an alternative embodiment, the hollow snack product obtained is in form of a cylindrical tunnel with closed ends having at least one cylindrical shape selected from a group consisting of a cylinder, a cylindrical curl, a cylindrical ring, a cylindrical S-shaped curve and combinations thereof. The process (100) ends at step (60).

In accordance with another aspect of the present disclosure, a hollow snack product is disclosed. The hollow snack product is prepared using the process (100) as described hereinbefore. Accordingly, the hollow snack product of the present disclosure comprises of 30-100% by weight of at least one base ingredient. The hollow snack product of the present disclosure has a moisture content in the range of 1-5% by weight, bulk density in the range of 0.15 g/cc-0.3 g/cc and dimensions as: Length in the range of 20-100 mm, Breadth in the range of 6-18 mm and Height in the range of 6-18 mm. The bulk density range is a characterising feature of the present disclosure. The hollow snack product of the present disclosure is crispy and crunchy in texture and has an Overall Acceptability Score of at least 7.5 and is in form of a horseshoe tunnel with closed ends having at least one cylindrical shape selected from a group consisting of a cylinder, a cylindrical curl, a cylindrical ring, a cylindrical S-shaped curve and combinations thereof. In an alternative embodiment, the hollow snack product is obtained in the form of a cylindrical tunnel with closed ends having at least one cylindrical shape and diameter in the range of 6-18 mm, wherein the at least one cylindrical shape is selected from a group consisting of a cylinder, a cylindrical curl, a cylindrical ring, a cylindrical S-shaped curve and combinations thereof. The hollow snack product of the present disclosure has a non-porous surface. As mentioned earlier, the non-porous surface is a characterising feature of the present disclosure. The hollow snack product of the present disclosure contains the base ingredient in any one form selected from a raw/unprocessed and processed, and comprises of at least one selected from a group consisting of, but not limited thereto, vegetables, fruits, millets, legumes, cereals, nuts, grains, pulses, beans, seeds and like, or combinations thereof. In an alternate embodiment, the hollow snack product of the present disclosure optionally contains at least one native starch along with the base ingredient. The native starch is selected from a group consisting of, but not limited thereto, potato starch, tapioca starch, corn starch, rice starch, bean starch and like, or combinations thereof. Quantity of the native starch present within the hollow snack product depends upon the starch content of the base ingredient. In yet another alternate embodiment, the hollow snack product of the present disclosure optionally contains at least one ingredient selected from a group consisting of, but not limited thereto, protein(s), protein isolate(s), protein concentrate(s), edible soluble fibre(s), edible insoluble fibre(s), oil, salt, sugar, yeast, flavouring agent, colouring agent, seasoning(s), spice(s), herb(s), vitamin(s) and like, or combinations thereof to enhance nutritional profile and organoleptic properties of the hollow snack product.

The hollow snack product of the present disclosure incorporates higher amounts of the base ingredients which are naturally sourced, and thus provides a healthy, nutritious, zero-added oil, 100% trans fatty acid free snack having consumer-desired organoleptic properties equivalent to fried snacks in the market, and thus can serve as a mid-meal snack. The hollow snack product of the present disclosure has sufficiently rigid and firm structure which can withstand all transportation, packaging, handling impact and prevent breakages.

The process (100) of the present disclosure preserves and retains natural taste of the base ingredients to provide the hollow snack product with high satiety levels upon consumption. The process (100) of the present disclosure ensures structure formation of the hollow snack product by use of the 2-stage drying process with low temperatures (slow drying), rather than fast explosive drying (ex. microwave drying).

The process (100) of the present disclosure eliminates completely the use of oil for frying or within the hollow snack product thus obtained. Further, the process (100) is very economical and versatile to be applied across the base ingredients, and hence can be carried out on a commercial scale with ease.

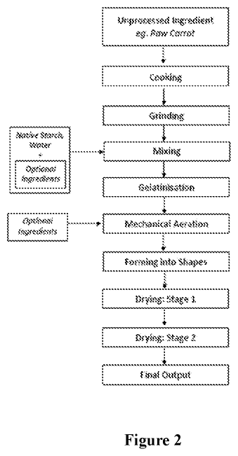

FIGS. 2-5 shows four different embodiments of the process (100) of the present disclosure.

Now, referring to FIG. 2, carrot was used as a base ingredient in raw form, and hence required the processing steps prior to mixing. Carrots were washed, peeled, cut into bite-sized chunks (or sliced into strips) and steam-cooked in a suitable equipment known in the art (for example, Thermomix®), at 120° C. for 20-25 minutes. Steaming deactivates the enzymes. Thereafter, the steamed carrots were grinded into a puree. The carrot puree was thereafter used in the process (100), and subjected to the steps of mixing with native starch, gelatinization of native starch, mechanical aeration, forming and 2-stage drying to prepare the end product in accordance with the present disclosure.

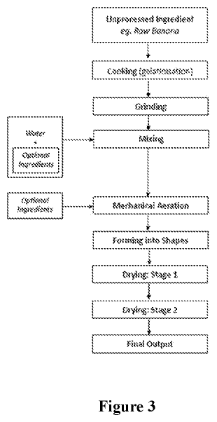

Referring to FIG. 3, banana was used as a base ingredient in raw form, and hence required the processing steps prior to mixing. Raw unpeeled green bananas were cut into halves (the peel was not removed to retain the color of bananas), and thereafter steam cooked in suitable equipment known in the art at 120° C. for 20-25 minutes. Steaming deactivates the enzymes and gelatinizes the starch present in the bananas. The cooked bananas are thereafter peeled and cut into small bite-sized form or slices. Since raw banana has a very high starch content and since the pre-defined values of starch content according to the present disclosure were met, the native starch was not added externally during the process (100). The cooked raw banana was grinded with water to obtain a puree, which was then used in the process (100) and was subjected to steps of mechanical aeration, forming and 2-stage drying to prepare the end product in accordance with the present disclosure. In this variation, since the native starch was not required to be added during the process (100), the step of gelatinization was also excluded.

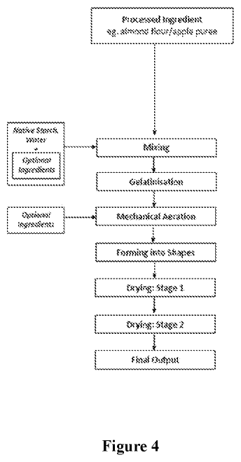

Referring to FIG. 4, almond flour was used as the base ingredient which was in processed form. Since the base ingredient was already processed, cooking and grinding was not required. The almond flour was mixed with the native starch and water such that the pre-defined values of starch content and starch:water ratio is maintained within proposed range thereof according to the present disclosure. Thereafter, the process (100) followed the steps of gelatinization, mechanical aeration, forming and 2-stage drying to prepare the end product in accordance with the present disclosure.

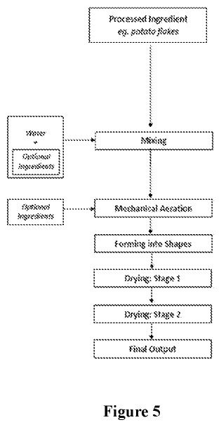

Referring to FIG. 5, potato flakes was used as the base ingredient which was in processed form. Since the base ingredient was already processed, cooking and grinding was not required. Further, since potato flakes has high starch content, and the pre-defined values of starch content according to the present disclosure were met, the native starch was not added externally during the process (100). In addition, the potato flakes have gelatinized starch, so step of gelatinization was excluded. Potato flakes was mixed with water, and thereafter, the process (100) followed the steps of mechanical aeration, forming and 2-stage drying to prepare the end product in accordance with the present disclosure.

### Experimentation Dataset:

The inventors of the present disclosure have carried out extensive experimentation to support the process (100) for preparation of the hollow snack product of the present disclosure. The experimentation was carried out using wide range of base ingredients in raw/unprocessed and processed form, and by varying other process parameters.

The microstructure of the product of the present disclosure is analyzed and characterized by using microscopy. In the analysis, hollow snack product is fractured at a statistically significant number of locations over the surface area of the crisp to reveal the internal microstructure in the outer surface. The outer surface is analyzed using microscopy, preferably scanning electron microscopy (SEM). The SEM images are taken to indicate that the structure of the end product is not porous. SEM was performed on Nova NanoSEM 450, SE mode at 5.00 kV. The magnification used were at 100×, 500×, 1000× &amp; 2000×.

The bulk density and viscosity are measured using processes and equipment known in the art.

Bulk density: The bulk density is calculated in g/cc. The bulk density considers the spaces between units or pieces of snack and represents the bulk volume, the volume of a portion or consumer unit, which in the snack sector is referenced by the content that fits in a bowl or bag. It has been measured with a 1-liter beaker flush with snack pieces. The relationship between the total weight of the pieces and the volume gives us the bulk density of the product.

Viscosity Measurement: Instrument: Digital Viscometer by ATAGO INDIA INSTRUMENTS
The sample is poured in the beaker up to the Reference line. Beaker will have a spindle name [A1, A2, A3] and a Reference line.
Beaker is attached to the stand and place the main unit on the stand. Sample is levelled with the spindle's reference line [sample should be in the center line on the spindle]
Spindle is set (A1, A2, A3), beaker type (L, s) and speed (rpm).
Torque is above 10% & less than 100%

Descriptive sensory analysis: Sensory analysis panel was recruited through the personnel department of the organization. The assessors were selected and trained as per ISO 6658:2017 standard. All Samples were analyzed descriptively for texture, taste, appearance and on the hedonic scale (1-9) for overall acceptability.

The base ingredients used during the experimentation and their average starch content (%) was as given in the following table:

| | Starch |
|---|---|
| Ingredient | % |
| Potato | ~20% |
| Beetroot | 0% |
| Potato Flakes | ~70% |
| Oats Flour | ~60% |
| Raw Green Jackfruit | ~16% |
| Strawberry Puree | ~0.04% |
| Raw Banana | ~20% |
| Mango Pulp | 0% |
| Chickpea Flour | ~14% |
| Carrot | ~1.3% |
| Almond Flour | ~0.7% |
| Pineapple | 0% |

### Experiment 1: Determination of Optimum Quantity of Starch Content (% Weight) and Starch: Water Ratio

According to the present disclosure, the pre-defined values of the starch content and starch:water ratio is in the range of 14-18% by weight and 1:4 to 1:5.5 respectively.

Extensive trials were carried out as follows to establish these optimum values using 4 different base ingredients, and 5 variations of the process for each base ingredient.

### Examples No. 1-5

Ingredient: Beetroot puree and Native Potato starch

Process: The process followed for each example is described below.

Cooking: Beetroot is wash and cut in halves. Peel is not removed to retain the color. It is steam-cooked with the Thermomix®. 500 g water is added to the Mixing Bowl of Thermomix®. Beetroot is placed in the Varoma® attachment and placed at the top of the Mixing Bowl of Thermomix® with the lid. The temperature setting is done at 120° C. at speed 2 for 20 minutes. Steaming deactivates the enzymes The beetroot is peeled after steaming.

Grinding: Thermomix® is used for grinding the steamed beetroot into a puree. It is added to the mixing bowl and is run at a speed of 7 for 30 sec.

Mixing: Native Starch is added to the beetroot puree in the Thermomix® as per the formulation. It is run for 50 sec at speed 2 to obtain a homogeneous mixture.

Gelatinization: To gelatinize the added starch in the homogeneous mixture, it is heated at a temperature setting of 70° C. for a time of 100 sec at speed 4 to achieve the temperature and it is maintained at the same temperature for a time of 8 minutes at speed 4 in the Thermomix®. The time and temperature are sufficient to gelatinize the starch in the mixture. The mixture cannot be sheeted and is difficult to handle due to the high viscosity. It is cooled to a temperature of 20° C.-30° C.

Mechanical Aeration: The gelatinized mixture is mechanically aerated in Thermomix® to incorporate air and make the mixture handleable. The speed is set up at 8 for a time of 60 sec. The aerated mixture becomes formable after the mechanical aeration.

5 Forming: The aerated mixture is formed into cylinder shapes manually with the help of a piping bag with a round nozzle with a 10 mm diameter. Long straight cylinders are formed. The long straight cylinders are further cut into small cylinders. The length of each cylinder is 70 mm and the diameter is 10 mm.

Drying Stage 1: The formed cylinders can be dried in a convection oven at a 10 temperature between 100° C. for 45 minutes. Drying Stage 2: The formed cylinders are further dried at a temperature between 120° C. for 40 min to obtain the end product.

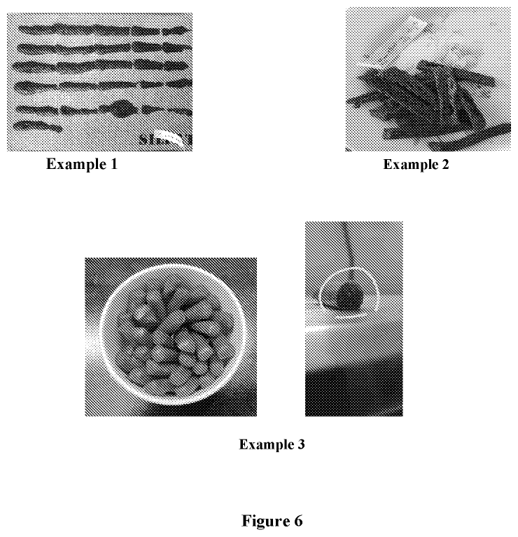

Results: See Table No. 1 below and refer FIG. 6

TABLE NO 1

| | | | | | | | Intermediary | |
|---|---|---|---|---|---|---|---|---|
| | | | | Mixture | | | Mixture Parmeters | |
| | | | | Composition | | | Geletanizesd | Aerated |
| Example | | Qty | Qty | Starch | Water | Ratio | mixture | Mixture |
| No. | Ingredient | (gm) | (%) | (%) | (%) | (Starch:water) | (viscosity) | (viscosity) |
| 1 | Beetroot | 190 | 95% | 0.00% | 83% | 1:17.02 | 7500 cp | 5,000 cp |
| | Puree | | | | | | | |
| | Native | 10 | 5% | 5% | 0.00% | | | |
| | Potato | | | | | | | |
| | Starch | | | | | | | |
| | Total | 200 | 100% | 5% | 83% | | | |
| 2 | Betroot | 178 | 89% | 0.00% | 78% | 1:7.26 | 10,200 cp | 8,500 cp |
| | Puree | | | | | | | |
| | Native | 22 | 11% | 11% | 0.00% | | | |
| | Potato | | | | | | | |
| | Starch | | | | | | | |
| | Total | 200 | 100% | 11% | 78% | | | |
| 3 | Betroot | 168 | 84% | 0.00% | 74% | 1:4.72 | equipment | 15-50K |
| | Puree | | | | | | shows | cp |
| | Native | 32 | 16% | 16% | 0.00% | | error | |
| | Potato | | | | | | | |
| | Starch | | | | | | | |
| | Total | 200 | 100% | 16% | 74% | | | |
| 4 | Betroot | 165.6 | 83% | 0.00% | 73% | 1:4.33 | equipment | 15-50K |
| | Puree | | | | | | shows | cp |
| | Native | 34.4 | 17% | 17% | 0.00% | | error | |
| | Potato | | | | | | | |
| | Starch | | | | | | | |
| | Total | 200 | 100% | 17% | 73% | | | |
| 5 | Betroot | 151 | 76% | 0.00% | 66% | 1:2.78 | equipment | equipment |
| | Puree | | | | | | shows | shows |
| | Native | 49 | 25% | 24% | 0.00% | | error | error |
| | Potato | | | | | | | |
| | Starch | | | | | | | |
| | Total | 200 | 100% | 24% | 67% | | | |

| | Output Product Parameters | | | | | | |
|---|---|---|---|---|---|---|---|
| | | % by | | | | | Overall |
| | | weight | | | | | Acceptability |
| Example | Bulk | of base | Moisture | Dimensions | | | (Hedonic |
| No. | density | ingredient | content | (l * b * h) | Appearance | Texture | Scale) |
| 1 | NOT applicable | | | | flat | chewy | 1 |
| | | | | | burned | non | |
| | | | | | watery | uniform | |
| | | | | | No | | |
| | | | | | defined | | |
| | | | | | shape | | |
| 2 | NOT applicable | | | | incomplete | chewy | 3 |
| | | | | | wall | | |
| | | | | | formation | | |
| | | | | | holes in | | |
| | | | | | the wall | | |
| | | | | | non | | |
| | | | | | uniform | | |
| 3 | 0.18 | [symbol] | 2% | L: 7 mm | uniform | uniform | 8 |
| | g/cc | | | B: 11 mm | smooth | light | |
| | | | | H: 11 mm | surface | airy | |
| | | | | | good | crispy | |
| | | | | | color | crunchy | |
| | | | | | hollow | | |
| 4 | 0.16 | [symbol] | 2% | L: 7 mm | uniform | uniform | 8 |
| | g/cc | | | B: 12 mm | smooth | light | |
| | | | | H: 12 mm | surface | airy | |
| | | | | | good | crispy | |
| | | | | | color | crunchy | |
| | | | | | hollow | | |

| | | | | |
|---|---|---|---|---|
| 5 | NOT applicable | Not | Hard | 3 |

| | |
|---|---|
| hollow | [symbol] |

[symbol]

indicates data missing or illegible when filed

### Examples No. 6-10

Ingredient: Potato flakes and Potato starch

Process: The process followed is same as the afore-mentioned process used for examples 1-5, except the following variations in process parameters.
Gelatinization: 65° C.,
Forming: 5 mm diameter, length 50 mm,
Drying Stage-1:120° C. for 50 minutes and Drying Stage-2: 150° C. for 20 minutes

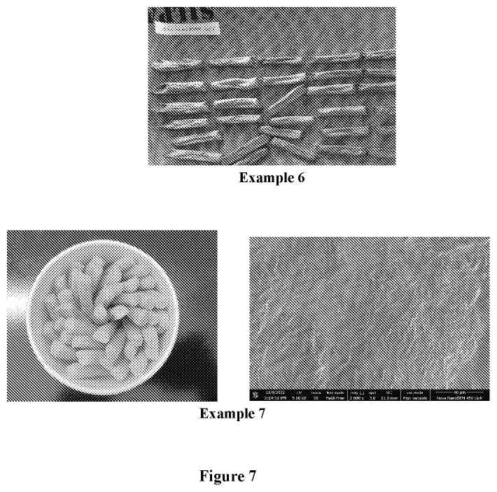

Results: See table No. 2 and refer FIG. 7

TABLE NO 2

| | | | | | | | Intermediary | |
|---|---|---|---|---|---|---|---|---|
| | | | | Mixture | | | Mixture Parmeters | |
| | | | | Composition | | | Geletanizesd | Aerated |
| Example | | Qty | Qty | Starch | Water | Ratio | mixture | Mixture |
| No. | Ingredient | (gm) | (%) | (%) | (%) | (Starch:water) | (viscosity) | (viscosity) |
| 6 | Potato | [symbol] | [symbol] | [symbol] | [symbol] | [symbol] | [symbol] | [symbol] |
| | Flakes | | | | | | | |
| | Potato | [symbol] | [symbol] | [symbol] | [symbol] | | | |
| | Starch | | | | | | | |
| | Water | [symbol] | [symbol] | [symbol] | [symbol] | | | |
| | Total | [symbol] | [symbol] | [symbol] | [symbol] | | | |
| 7 | Potato | [symbol] | [symbol] | [symbol] | [symbol] | 1:4.74 | equipment | [symbol] |
| | Flakes | | | | | | shows error | |
| | Potato | [symbol] | [symbol] | [symbol] | [symbol] | | | |
| | Starch | | | | | | | |
| | Water | [symbol] | [symbol] | [symbol] | [symbol] | | | |
| | Total | [symbol] | [symbol] | [symbol] | [symbol] | | | |
| 8 | Potato | [symbol] | [symbol] | [symbol] | [symbol] | [symbol] | equipment | [symbol] |
| | Flakes | | | | | | shows error | |
| | Potato | [symbol] | [symbol] | [symbol] | [symbol] | | | |
| | Starch | | | | | | | |
| | Water | [symbol] | [symbol] | [symbol] | [symbol] | | | |
| | Total | [symbol] | [symbol] | [symbol] | [symbol] | | | |
| 9 | Potato | [symbol] | [symbol] | [symbol] | [symbol] | 1:3.51 | equipment | equipment |
| | Flakes | | | | | | shows error | shows error |
| | Potato | [symbol] | [symbol] | [symbol] | [symbol] | | | |
| | Starch | | | | | | | |
| | Water | [symbol] | [symbol] | [symbol] | [symbol] | | | |
| | Total | [symbol] | [symbol] | [symbol] | [symbol] | | | |
| 10 | Potato | [symbol] | [symbol] | [symbol] | [symbol] | 1:2.03 | equipment | equipment |
| | Flakes | | | | | | shows error | shows error |
| | Potato | [symbol] | [symbol] | [symbol] | [symbol] | | | |
| | Starch | | | | | | | |
| | Water | [symbol] | [symbol] | [symbol] | [symbol] | | | |
| | Total | [symbol] | [symbol] | [symbol] | [symbol] | | | |

| | Output Product Parameters | | | | | | |
|---|---|---|---|---|---|---|---|
| | | % by | | | | | Overall |
| | | weight | | | | | Acceptability |
| Example | Bulk | of base | Moisture | Dimensions | | | (Hedonic |
| No. | density | ingredient | content | (l * b * h) | Appearance | Texture | Scale) |
| 6 | NOT applicable | | | | [symbol] | [symbol] | [symbol] |
| 7 | [symbol] | [symbol] | [symbol] | [symbol] | [symbol] | [symbol] | [symbol] |
| 8 | [symbol] | [symbol] | [symbol] | [symbol] | [symbol] | [symbol] | [symbol] |

| | | | | |
|---|---|---|---|---|
| 9 | NOT applicable | Not hollow | [symbol] | [symbol] |
| 10 | NOT applicable | Not hollow | [symbol] | [symbol] |

[symbol]

indicates data missing or illegible when filed

### Examples No. 11-15

Ingredient: Oats flour

Process: The process followed is same as the afore-mentioned process used for examples 1-5, except the following variations in process parameters.
Oats flour is not cooked, the process starts from the mixing step,
Forming: round nozzle with a 15 mm diameter and length kept at 40 mm,
Drying Stage-1:130° C. for 40 minutes, Drying Stage-2:170° C. for 15 minutes.

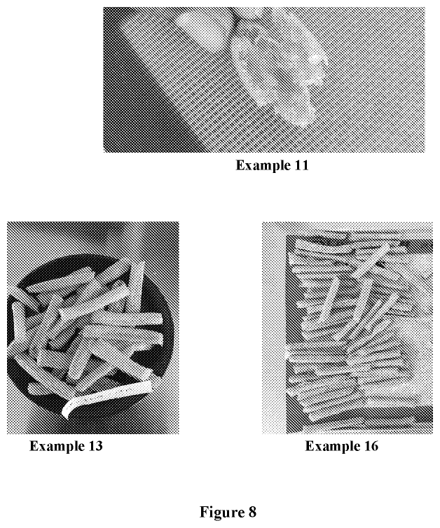

Results: See table No. 3 and refer FIG. 8

TABLE NO 3

| | | | | | | | Intermediary | |
|---|---|---|---|---|---|---|---|---|
| | | | | Mixture | | | Mixture Parmeters | |
| | | | | Composition | | | Geletanizesd | Aerated |
| Example | | Qty | Qty | Starch | Water | Ratio | mixture | Mixture |
| No. | Ingredient | (gm) | (%) | (%) | (%) | (Starch:water) | (viscosity) | (viscosity) |
| 11 | Oats Flour | [symbol] | [symbol] | [symbol] | [symbol] | 1:15.12 | [symbol] | [symbol] |
| | Water | [symbol] | [symbol] | [symbol] | [symbol] | | | |
| | Total | [symbol] | [symbol] | [symbol] | [symbol] | | | |
| 12 | Oats Flour | [symbol] | [symbol] | [symbol] | [symbol] | 1:6.78 | [symbol] | [symbol] |
| | Water | [symbol] | [symbol] | [symbol] | [symbol] | | | |
| | Total | [symbol] | [symbol] | [symbol] | [symbol] | | | |
| 13 | Oats Flour | [symbol] | [symbol] | [symbol] | [symbol] | 1:5.12 | equipment | [symbol] |
| | Water | [symbol] | [symbol] | [symbol] | [symbol] | | shows error | |
| | Total | [symbol] | [symbol] | [symbol] | [symbol] | | | |
| 14 | Oats Flour | [symbol] | [symbol] | [symbol] | [symbol] | 1:4.40 | equipment | [symbol] |
| | Water | [symbol] | [symbol] | [symbol] | [symbol] | | shows error | |
| | Total | [symbol] | [symbol] | [symbol] | [symbol] | | | |
| 15 | Oats Flour | [symbol] | [symbol] | [symbol] | [symbol] | 1:2.15 | equipment | equipment |
| | Water | [symbol] | [symbol] | [symbol] | [symbol] | | shows error | shows error |
| | Total | [symbol] | [symbol] | [symbol] | [symbol] | | | |

| | Output Product Parameters | | | | | | |
|---|---|---|---|---|---|---|---|
| | | % by | | | | | Overall |
| | | weight | | | | | Acceptability |
| Example | Bulk | of base | Moisture | Dimensions | | | (Hedonic |
| No. | density | ingredient | content | (l * b * h) | Appearance | Texture | Scale) |
| 11 | NOT applicable | | | | [symbol] | [symbol] | [symbol] |
| 12 | NOT applicable | | | | [symbol] | [symbol] | [symbol] |
| 13 | [symbol] | [symbol] | [symbol] | [symbol] | [symbol] | [symbol] | [symbol] |
| 14 | [symbol] | [symbol] | [symbol] | [symbol] | [symbol] | [symbol] | [symbol] |

| | | | | |
|---|---|---|---|---|
| 15 | NOT applicable | [symbol] | [symbol] | [symbol] |

[symbol]

indicates data missing or illegible when filed

### Example No. 16-20

Ingredient: Raw green jackfruit puree

Process: The process followed is same as the afore-mentioned process used for examples 1-5, except the following variations in process parameters.
Gelatinization is not required,
Drying stage-1:120° C. for 40 minutes, Drying stage-2:170° C. for 20 minutes

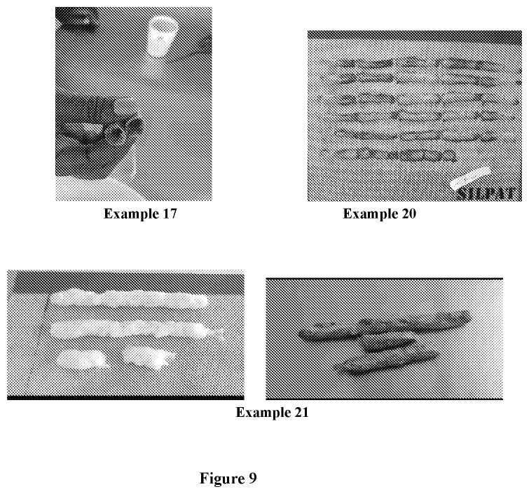

Results: See table No. 4 and refer FIGS. 8 and 9

TABLE NO 4

| | | | | | | | Geletanizesd | Aerated |
|---|---|---|---|---|---|---|---|---|
| Example | | Qty | Qty | Starch | Water | Ratio | mixture | Mixture |
| No. | Ingredient | (gm) | (%) | (%) | (%) | (Starch:water) | (viscosity) | (viscosity) |
| 16 | [symbol] | [symbol] | [symbol] | [symbol] | [symbol] | [symbol] | [symbol] | [symbol] |
| | Water | [symbol] | [symbol] | [symbol] | [symbol] | | | |
| | Total | [symbol] | [symbol] | [symbol] | [symbol] | | | |
| 17 | [symbol] | [symbol] | [symbol] | [symbol] | [symbol] | [symbol] | [symbol] | [symbol] |
| | Water | [symbol] | [symbol] | [symbol] | [symbol] | | | |
| | Total | [symbol] | [symbol] | [symbol] | [symbol] | | | |
| 18 | [symbol] | [symbol] | [symbol] | [symbol] | [symbol] | [symbol] | [symbol] | [symbol] |
| | Water | [symbol] | [symbol] | [symbol] | [symbol] | | | |
| | Total | [symbol] | [symbol] | [symbol] | [symbol] | | | |
| 19 | [symbol] | [symbol] | [symbol] | [symbol] | [symbol] | [symbol] | [symbol] | [symbol] |
| | Water | [symbol] | [symbol] | [symbol] | [symbol] | | | |
| | Total | [symbol] | [symbol] | [symbol] | [symbol] | | | |
| 20 | [symbol] | [symbol] | [symbol] | [symbol] | [symbol] | [symbol] | [symbol] | [symbol] |
| | Water | [symbol] | [symbol] | [symbol] | [symbol] | | | |
| | Total | [symbol] | [symbol] | [symbol] | [symbol] | | | |

| | | % by | | | | | Overall |
|---|---|---|---|---|---|---|---|
| | | weight | | | | | Acceptability |
| Example | Bulk | of base | Moisture | Dimensions | | | (Hedonic |
| No. | density | ingredient | content | (l * b * h) | Appearance | Texture | Scale) |
| 16 | [symbol] | [symbol] | [symbol] | [symbol] | [symbol] | [symbol] | [symbol] |
| 17 | [symbol] | [symbol] | [symbol] | [symbol] | [symbol] | [symbol] | [symbol] |

| | | | | |
|---|---|---|---|---|
| 18 | NA | [symbol] | [symbol] | [symbol] |
| 19 | NA | [symbol] | [symbol] | [symbol] |
| 20 | NA | [symbol] | [symbol] | [symbol] |

[symbol]

indicates data missing or illegible when filed

### Experiment 2: Establish the Importance of Aeration Step

Further trials were carried out to establish that gelatinized mixture is not machinable (sheetable or pipeable) without aeration. Also, trials were carried out to establish that the end product made without aeration has inferior structure.

### Example No. 21

Ingredient: Pineapple puree and Native potato starch

Process: The process followed is same as the afore-mentioned process used for examples 1-5, except the following variations in process parameters.
Cooking is not performed for pineapple,
Mechanical Aeration: The gelatinized mixture is not aerated,
Forming: The non-aerated mixture is put into a piping bag. With pressure the piping bag bursts and no uniform shapes are formed. The mixture is then shaped manually to obtain a shape similar to cylinder, the surface is non-uniform

Results: See table No. 5 and refer FIG. 9

TABLE NO 5

| | | | | | | | Intermediary | |
|---|---|---|---|---|---|---|---|---|
| | | | | Mixture | | | Mixture Parmeters | |
| | | | | Composition | | | Geletanizesd | Aerated |
| Example | | Qty | Qty | Starch | Water | Ratio | mixture | Mixture |
| No. | Ingredient | (gm) | (%) | (%) | (%) | (Starch:water) | (viscosity) | (viscosity) |
| 21 | Pineapple | 170 | 85% | 0.00% | 73% | | equipment | NA |
| | Puree | | | | | | shows error | |
| | Native | 30 | 15% | 14.55% | 0.45% | | | |
| | Potato | | | | | | | |
| | Starch | | | | | | | |
| | Total | 200 | 100.00% | 14.55% | 73.55% | | | |

| | Output Product Parameters | | | | | | |
|---|---|---|---|---|---|---|---|
| | | % by | | | | | Overall |
| | | weight | | | | | Acceptability |
| Example | Bulk | of base | Moisture | Dimensions | | | (Hedonic |
| No. | density | ingredient | content | (l * b * h) | Appearance | Texture | Scale) |

| | | | | |
|---|---|---|---|---|
| 21 | NA | rough | non | 2 |

| | |
|---|---|
| surface | uniform |
| burnt | hard |
| not hollow | |
| Blisters | |
| no defined | |
| shape | |

### Experiment 3: Establish that the Aerated Mixture is ‘Not’ Sheetable, but Only ‘Pipe-Able’

Further trials were carried out to establish that the aerated mixture is not sheetable, but only pipeable.

### Example No. 22

Ingredient: Pineapple puree and Native potato starch

Process: The process followed is same as the afore-mentioned process used for examples 1-5, except the following variations in process parameters
Cooking is not performed for pineapple,
Forming: The aerated mixture is sheeted with a rolling pin. Due to the high stickiness, the sheet is not formed. Manually with force, the mixture is spread on the baking mat. It is unevenly spread

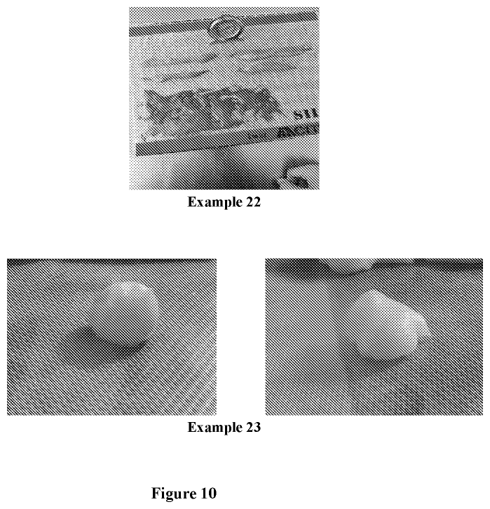

Results: See table No. 6 and refer FIG. 10

TABLE NO 6

| | | | | | | | Intermediary | |
|---|---|---|---|---|---|---|---|---|
| | | | | Mixture | | | Mixture Parmeters | |
| | | | | Composition | | | Geletanizesd | Aerated |
| Example | | Qty | Qty | Starch | Water | Ratio | mixture | Mixture |
| No. | Ingredient | (gm) | (%) | (%) | (%) | (Starch:water) | (viscosity) | (viscosity) |
| 22 | Pineapple | [symbol] | [symbol] | [symbol] | [symbol] | [symbol] | equipment | 15-50K cp |
| | Puree | | | | | | shows error | |
| | [symbol] | [symbol] | [symbol] | [symbol] | [symbol] | | | |
| | Total | [symbol] | [symbol] | [symbol] | [symbol] | | | |

| | Output Product Parameters | | | | | | |
|---|---|---|---|---|---|---|---|
| | | % by | | | | | Overall |
| | | weight | | | | | Acceptability |
| Example | Bulk | of base | Moisture | Dimensions | | | (Hedonic |
| No. | density | ingredient | content | (l * b * h) | Appearance | Texture | Scale) |

| | | | | |
|---|---|---|---|---|
| 22 | NA | [symbol] | [symbol] | 1 |

[symbol]

indicates data missing or illegible when filed

### Experiment 4: Establish the Criticality of Piping into Cylinder Shape

### Example No. 23

Ingredient: Pineapple puree and Native potato starch

Process: The process followed is same as the afore-mentioned process used for examples 1-5, except the following variations in process parameters
Cooking is not performed for pineapple,
Forming: The aerated mixture is dropped to form ball-like structure
Dimensions: Base-20 mm and Height-20 mm

Results: See table No. 7 and refer FIG. 10

TABLE NO 7

| | | | | | | | Intermediary | |
|---|---|---|---|---|---|---|---|---|
| | | | | Mixture | | | Mixture Parmeters | |
| | | | | Composition | | | Geletanizesd | Aerated |
| Example | | Qty | Qty | Starch | Water | Ratio | mixture | Mixture |
| No. | Ingredient | (gm) | (%) | (%) | (%) | (Starch:water) | (viscosity) | (viscosity) |
| 23 | Pineapple | 170 | 85% | 0.00% | 73% | 1:5.05 | equipment | 15-50K cp |
| | Puree | | | | | | shows error | |
| | Native | 30 | 15% | 14.55% | 0.45% | | | |
| | Potato | | | | | | | |
| | Starch | | | | | | | |
| | Total | 200 | 100.00% | 14.55% | [symbol] | | | |

| | Output Product Parameters | | | | | | |
|---|---|---|---|---|---|---|---|
| | | % by | | | | | Overall |
| | | weight | | | | | Acceptability |
| Example | Bulk | of base | Moisture | Dimensions | | | (Hedonic |
| No. | density | ingredient | content | (l * b * h) | Appearance | Texture | Scale) |

| | | | | |
|---|---|---|---|---|
| 23 | NA | not | non | [symbol] |

| | |
|---|---|
| uniformly | uniformly |
| hollow | crispy |
| thick | Hard |
| rough | |
| surface | |

[symbol]

indicates data missing or illegible when filed

### Experiment 5: Establish Alternate Embodiments of the Process of the Present Disclosure with Same End Result (i.e. Hollow Snack Product)

### Example No. 24

Base ingredient: Vegetable

Ingredient: Carrot puree and Native potato starch

Process: The process followed is same as the afore-mentioned process used for examples 1-5.

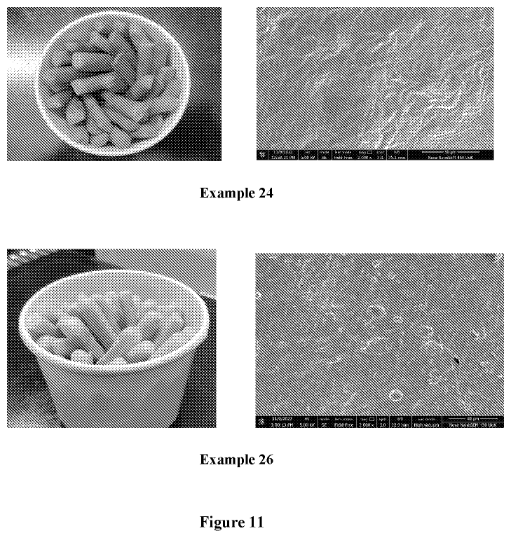

Results: See table No. 8 and refer FIG. 11

TABLE NO 8

| | | | | | | | Intermediary | |
|---|---|---|---|---|---|---|---|---|
| | | | | Mixture | | | Mixture Parmeters | |
| | | | | Composition | | | Geletanizesd | Aerated |
| Example | | Qty | Qty | Starch | Water | Ratio | mixture | Mixture |
| No. | Ingredient | (gm) | (%) | (%) | (%) | (Starch:water) | (viscosity) | (viscosity) |
| 24 | Carrot Puree | 167 | 84% | 1.09% | 71.81% | 1:4.23 | equipment | 15-50K cp |
| | Native | 33 | 17% | 16.01% | 0.50% | | shows error | |
| | Potato | | | | | | | |
| | Starch | | | | | | | |
| | Total | 200 | 100% | 17.00% | 72.00% | | | |

| | Output Product Parameters | | | | | | |
|---|---|---|---|---|---|---|---|
| | | % by | | | | | Overall |
| | | weight | | | | | Acceptability |
| Example | Bulk | of base | Moisture | Dimensions | | | (Hedonic |
| No. | density | ingredient | content | (l * b * h) | Appearance | Texture | Scale) |
| 24 | [symbol] | [symbol] | 2% | L: 70 mm | uniform | uniform | [symbol] |
| | | | | B: 12 mm | smooth | light | |
| | | | | H: 12 mm | surface | airy | |
| | | | | | good color | crispy | |
| | | | | | hollow | crunchy | |

[symbol]

indicates data missing or illegible when filed

### Example No. 25

Base ingredient: Fruit

Other ingredients for nutrition profile enhancement: Addition of fiber and protein

Ingredient: Strawberry puree concentrate, Native tapioca starch, Brown rice protein isolate and Citrus fiber

Process: The process followed is same as the afore-mentioned process used for examples 1-5, except the following variations in process parameters.
Cooking and grinding are not performed for Strawberry, Processed puree is procured from a supplier at 28-degree brix,
Mixing: During the mixing step, protein & citrus fiber are added to the mixture to enhance the protein and fiber content,
Forming: Diameter—10 mm, length—50 mm

Results: See table No. 9

TABLE NO 9

| | | | | | | | Intermediary | |
|---|---|---|---|---|---|---|---|---|
| | | | | Mixture | | | Mixture Parmeters | |
| | | | | Composition | | | Geletanizesd | Aerated |
| Example | | Qty | Qty | Starch | Water | Ratio | mixture | Mixture |
| No. | Ingredient | (gm) | (%) | (%) | (%) | (Starch:water) | (viscosity) | (viscosity) |
| 25 | Strawberry | 156 | 78% | [symbol] | 71.00% | 1:5.26 | equipment | 15-50K cp |
| | Puree | | | | | | shows error | |
| | Concentrate | | | | | | | |
| | Native | 28 | 14% | 14.00% | 0.42% | | | |
| | tapioca | | | | | | | |
| | starch | | | | | | | |
| | Brown rice | 10 | 5% | 0.00% | 0.00% | | | |
| | protein | | | | | | | |
| | isolate | | | | | | | |
| | Citrus Fiber | 6 | 3% | 0 | [symbol] | | | |
| | Total | 200 | 100% | 14.03% | [symbol] | | | |

| | Output Product Parameters | | | | | | |
|---|---|---|---|---|---|---|---|
| | | % by | | | | | Overall |
| | | weight | | | | | Acceptability |
| Example | Bulk | of base | Moisture | Dimensions | | | (Hedonic |
| No. | density | ingredient | content | (l * b * h) | Appearance | Texture | Scale) |
| 25 | 0.20 | 37.17% | 3% | L: 50 mm | uniform | uniform | 8 |
| | g/cc | | | B: 11 mm | smooth | light | |
| | | | | H: 11 mm | surface | airy | |
| | | | | | good color | crispy | |
| | | | | | hollow | crunchy | |

[symbol]

indicates data missing or illegible when filed

### Example No. 26

Starch is not added, enhancement in organoleptic properties, and ability to have absolute control on amount of oil the product will have.

Ingredient: Raw banana puree, water, oil, turmeric, salt, black pepper

Process: The process followed is described below.

Cooking: Unpeeled Raw Green bananas are cut into halves. The peel is not removed to retain the color of bananas. Steaming deactivates the enzymes and gelatinizes the starch present in the bananas. The cooked bananas are peeled and cut into small bite-sized form or slices.

Grinding & Mixing: It is difficult to grind cooked Raw Green bananas into a puree with simple grinding techniques. Raw Green Banana has a very high starch content. Water is added to the Thermomix® mixing bowl as per the recipe. It is set at a temperature between 40° C.-50° C. for 10 min at speed 2. The Cooked raw green bananas get purred and blended with water to obtain a homogeneous mixture.

Native starch is not added to the mixture, hence, a separate gelatinization step is not required in this case.

Mechanical Aeration: The homogeneous & gelatinized mixture is mechanically aerated in Thermomix® to incorporate air and make the mixture pipe-able. The speed is set up at 8 for a time of 150 sec.

Forming: The aerated mixture is formed into cylinder shapes manually with the help of a piping bag with a round nozzle with a 10 mm diameter. Long straight cylinders are formed. The long straight cylinders are further cut into small cylinders. The length of each cylinder is 70 mm and the diameter is 10 mm.

Drying Stage-1: The formed cylinders can be dried in a conventional oven at a temperature between 100° C. for 50 minutes The hollow structure is formed during the drying stage 1.

Drying Stage-2: The formed cylinders are further dried at a temperature between 160° C. for 20 minutes.

Results: See table No. 10 and refer FIG. 11

TABLE NO 10

| | | | | | | | Intermediary | |
|---|---|---|---|---|---|---|---|---|
| | | | | Mixture | | | Mixture Parmeters | |
| | | | | Composition | | | Geletanizesd | Aerated |
| Example | | Qty | Qty | Starch | Water | Ratio | mixture | Mixture |
| No. | Ingredient | (gm) | (%) | (%) | (%) | (Starch:water) | (viscosity) | (viscosity) |
| 26 | Raw Banana | [symbol] | [symbol] | [symbol] | [symbol] | 1:5.49 | equipment | 15-50K cp |
| | Puree | | | | | | shows error | |
| | Water | [symbol] | [symbol] | [symbol] | [symbol] | | | |
| | Oil | [symbol] | [symbol] | [symbol] | [symbol] | | | |
| | [symbol] | [symbol] | [symbol] | [symbol] | [symbol] | | | |
| | Salt | [symbol] | [symbol] | [symbol] | [symbol] | | | |
| | Black Pepper | [symbol] | [symbol] | [symbol] | [symbol] | | | |
| | Total | [symbol] | [symbol] | [symbol] | [symbol] | | | |

| | Output Product Parameters | | | | | | |
|---|---|---|---|---|---|---|---|
| | | % by | | | | | Overall |
| | | weight | | | | | Acceptability |
| Example | Bulk | of base | Moisture | Dimensions | | | (Hedonic |
| No. | density | ingredient | content | (l * b * h) | Appearance | Texture | Scale) |
| 26 | [symbol] | 71% | 2% | L: 70 mm | uniform | uniform | [symbol] |
| | | | | B: 10 mm | smooth | moderately | |
| | | | | H: 11 mm | surface | light | |
| | | | | | good color | airy | |
| | | | | | hollow | crispy | |
| | | | | | | crunchy | |

[symbol]

indicates data missing or illegible when filed

### Example No. 27

Base ingredients: combinations of different base ingredients used, Legume as a base ingredient

Ingredient: Mango pulp and Chickpea flour

Process: The process followed is same as the afore-mentioned process used for examples 1-5, except the following variations in process parameters.
Cooking is not performed for chickpea flour and mango. Mango is peeled, cut & ground to a puree

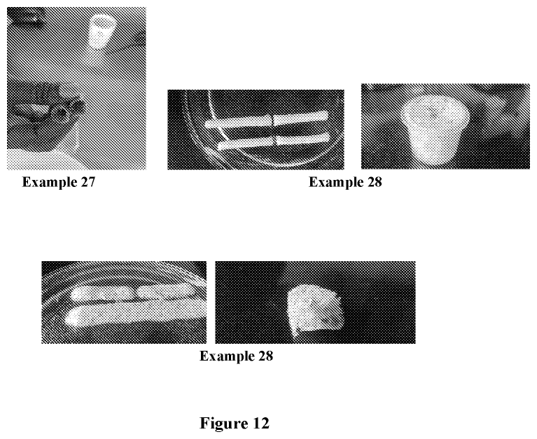

Results: See table No. 11 and refer FIG. 12

TABLE NO 11

| | | | | | | | Intermediary | |
|---|---|---|---|---|---|---|---|---|
| | | | | Mixture | | | Mixture Parmeters | |
| | | | | Composition | | | Geletanizesd | Aerated |
| Example | | Qty | Qty | Starch | Water | Ratio | mixture | Mixture |
| No. | Ingredient | (gm) | (%) | (%) | (%) | (Starch:water) | (viscosity) | (viscosity) |
| 27 | Mango pulp | 140 | 70% | 0.00% | [symbol] | 1:4.14 | equipment | 15-50K cp |
| | Chickpea | 60 | 30% | 14.00% | [symbol] | | shows error | |
| | Flour | | | | | | | |
| | Total | 200 | 100% | 14.00% | [symbol] | | | |

| | Output Product Parameters | | | | | | |
|---|---|---|---|---|---|---|---|
| | | % by | | | | | Overall |
| | | weight | | | | | Acceptability |
| Example | Bulk | of base | Moisture | Dimensions | | | (Hedonic |
| No. | density | ingredient | content | (l * b * h) | Appearance | Texture | Scale) |
| 27 | [symbol] | 100.00% | 2% | L: 70 mm | uniform | uniform | [symbol] |
| | | | | B: 12 mm | smooth | light | |
| | | | | H: 12 mm | surface | airy | |
| | | | | | hollow | cripsy | |
| | | | | | | crunchy | |

[symbol]

indicates data missing or illegible when filed

### Experiment 6: Establish Importance of 2-Stage Drying Process Against Microwave/Flash Drying

### Example No. 28

Ingredient: Potato flakes and potato starch

Process: The process followed is same as the afore-mentioned process used for example no. 6, except the following variation in process parameters.
Forming: The cylinder is formed with a length of 60 mm with a diameter of 5 mm, a mould is used with 9 g mixture
Top Diameter: 40 mm, Height: 20 mm, Bottom Diameter: 20 mm
Slow convection oven drying is replaced by rapid dehydration method i.e. microwave drying; both the shapes are kept for 60 seconds in microwave.

Results: See table No. 12 and refer FIG. 12

TABLE NO 12

| | | | | | | | Intermediary | |
|---|---|---|---|---|---|---|---|---|
| | | | | Mixture | | | Mixture Parmeters | |
| | | | | Composition | | | Geletanizesd | Aerated |
| Example | | Qty | Qty | Starch | Water | Ratio | mixture | Mixture |
| No. | Ingredient | (gm) | (%) | (%) | (%) | (Starch:water) | (viscosity) | (viscosity) |
| 28 | Potato | [symbol] | [symbol] | [symbol] | [symbol] | [symbol] | equipment | 15-50K cp |
| | Flakes | | | | | | shows error | |
| | Potato | [symbol] | [symbol] | [symbol] | [symbol] | | | |
| | Starch | | | | | | | |
| | Water | [symbol] | [symbol] | [symbol] | [symbol] | | | |
| | Total | [symbol] | [symbol] | [symbol] | [symbol] | | | |

| | Output Product Parameters | | | | | | |
|---|---|---|---|---|---|---|---|
| | | % by | | | | | Overall |
| | | weight | | | | | Acceptability |
| Example | Bulk | of base | Moisture | Dimensions | | | (Hedonic |
| No. | density | ingredient | content | (l * b * h) | Appearance | Texture | Scale) |
| 28 | [symbol] | [symbol] | [symbol] | [symbol] | [symbol] | [symbol] | 2 |

[symbol]

indicates data missing or illegible when filed

### Experiment 7: Establish that the Process Works with Starch Having Amylopectin <80%. Establish that the Process can be Used to Prepare the End Product in Varied Shapes-Such as Curved Shapes, Curls Etc

Further experiments were carried out to establish that the process is not limited by amylopectin content of the starch and gives similar results for the starch having amylopectin <80% as well. This is a characterizing feature of the present disclosure. To establish this, in the following example Raw green Jackfruit was used as the starting material having around 50% to 70% amylopectin content.

### Example No. 29

Ingredient: Raw green jackfruit puree

Process: The process followed is same as the afore-mentioned process used for example no. 16, except the following variation in process parameters
1. Forming is done in varied shapes:
   a) curl,
   b) ring, and
   c) S-shaped curve

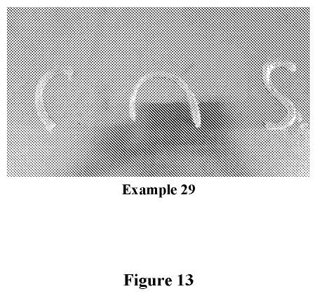

Results: See table No. 13 and refer FIG. 13

TABLE NO 13

| | | | | | | | Intermediary | |
|---|---|---|---|---|---|---|---|---|
| | | | | Mixture | | | Mixture Parmeters | |
| | | | | Composition | | | Geletanizesd | Aerated |
| Example | | Qty | Qty | Starch | Water | Ratio | mixture | Mixture |
| No. | Ingredient | (gm) | (%) | (%) | (%) | (Starch:water) | (viscosity) | (viscosity) |
| 29 | [symbol] | [symbol] | [symbol] | [symbol] | [symbol] | 1:4.14 | equipment | [symbol] |
| | Water | [symbol] | [symbol] | [symbol] | [symbol] | | shows error | |
| | Total | [symbol] | [symbol] | [symbol] | [symbol] | | | |

| | Output Product Parameters | | | | | | |
|---|---|---|---|---|---|---|---|
| | | % by | | | | | Overall |
| | | weight | | | | | Acceptability |
| Example | Bulk | of base | Moisture | Dimensions | | | (Hedonic |
| No. | density | ingredient | content | (l * b * h) | Appearance | Texture | Scale) |
| 29 | [symbol] | 100% | 2% | [symbol] | uniform | uniform | 8 |
| | | | | | smooth | light | |
| | | | | | surface | airy | |
| | | | | | good color | crispy | |
| | | | | | hollow | crunchy | |

[symbol]

indicates data missing or illegible when filed

### Inference:

It can be inferred from the extensive experimentation carried out as demonstrated above, that the choice of ingredients; the characteristic percentages and ranges in which the ingredients are used; the characteristic physicochemical properties of the ingredients; the characteristic process steps (incl. mechanical aeration, piping into a cylindrical shape, two step drying instead of flash drying) and process parameters; the characteristic sequence of carrying out the process steps-together result in a superlative product having a uniform and standout shape (expanded internally hollow with dense, non-porous close ended walls), and uniform texture. In other words, the synergistic effect of the choice of ingredients; the characteristic percentages and ranges in which the ingredients are used; the characteristic physicochemical properties of the ingredients; the characteristic process steps (incl. mechanical aeration, piping into a cylindrical shape, two step drying instead of flash drying) and process parameters; the characteristic sequence of carrying out the process steps is a superlative product having a uniform and standout shape (expanded internally hollow with dense, non-porous close ended walls), and uniform texture.

To summarize, the present disclosure address concern of using non-workable dough to prepare the hollow snack product without gluten or without need of any additives, in contrast to existing technologies. The process (100) of the present disclosure allows use of mixture that is made from starch material and water and obtain the end product i.e. the hollow snack product without use of gluten or any other additives. The present disclosure thus advantageously allows the creation of non-fried, non-extruded expanded snack food products with kitchen ingredients and also having 30-100% of base ingredients in the final product. The process (100) of the present disclosure is very versatile and can be applied across base ingredients to prepare the consumer-desired snack product which is hollow, crispy and crunchy in texture and nutritious with zero-added oil content. The hollow snack product prepared by the process (100) of the present disclosure has organoleptic properties similar to their fried-snack counterparts. Further, the process is feasible to be applied across commercial scale for preparation of wide range of healthy, nutritious snack products with consumer-desired organoleptic properties.

The foregoing objects of the invention are accomplished, and the problems and shortcomings associated with prior art solutions and approaches are overcome by the proposed invention described in the present embodiment. The embodiments described herein above are non-limiting. While embodiments of the present invention have been illustrated and described, various modifications can be made without departing from the scope of the invention. The foregoing descriptive matter is to be interpreted merely as an illustration of the concept of the present disclosure and it is in no way to be construed as a limitation. Description of terminologies, concepts and processes known to persons acquainted with technology has been avoided for the sake of brevity.

### TECHNICAL ADVANTAGES AND ECONOMIC SIGNIFICANCE

The technical advantages and economic significance of the process (100) of the present disclosure are presented herein after:
1. The process (100) utilizes naturally sourced ingredients to prepare snack products with organoleptic properties comparable to fried snack counterparts.
2. The process (100) is economical and can be carried out on a commercial scale with ease.
3. The process (100) is versatile and offers absolute control on oil and nutrition content within the end product as desired by the consumer.
4. The process (100) provides the hollow snack product which is nutritious, zero-added oil crisp-crunchy snack that can serve as a mid-meal snack.
5. The process (100) allows preparation of a clean label product made up of natural familiar kitchen ingredients without use of any additives, and therefore enhances nutritional value of the end product.
6. The process (100) eliminates frying to prepare the hollow snack product and hence does not require use of any frying oil, and hence avoids wastage of oil.
7. The process (100) is versatile and can be applied across various starting materials to obtain the same end result i.e. the hollow snack product.

We claim:

1. A process (100) for preparation of a hollow snack product, the process (100) comprising the steps of:
a. admixing at least one base ingredient with at least one native starch and water to obtain a homogeneous mixture, wherein, the base ingredient, the native starch and the water is mixed in a pre-determined quantity such that a total quantity of starch content and starch:water ratio is maintained at pre-defined values being in the range of 14-18% by weight and 1:4 to 1:5.5 respectively within the homogeneous mixture;
b. subjecting the homogenous mixture to a gelatinization temperature in the range of 60-90° C. followed by cooling thereof to obtain a gelatinized mixture, wherein the total quantity of starch present within the homogeneous mixture undergoes gelatinization to obtain the gelatinized mixture having gelatinized starch present therewithin;
c. mechanically aerating the gelatinized mixture uniformly using a mechanically aerating apparatus for a time period ranging from 30-120 sec. causing air to entrap within the gelatinized starch and obtain an aerated mixture, the aerated mixture having viscosity in the range of 15,000 to 50,000 cp and being capable of forming;
d. forming the aerated mixture using a piping apparatus into at least one cylindrical shape followed by cutting thereof to obtain a plurality of formed cylindrical pieces each having shape corresponding to the at least one cylindrical shape, and a diameter and length in the range of 5-15 mm and 20-100 mm respectively; and
e. subjecting the plurality of formed cylindrical piece(s) to a 2-stage drying process using at least one dryer, wherein, in a stage-1 drying process, the formed cylindrical piece(s) are initially exposed to a temperature in the range of 100 to 160° C. until water converts into steam and expands along with expansion of entrapped air to exert an outward force from centre of the formed cylindrical piece(s) while the gelatinized starch prevents escape of the air therefrom and therethrough thereby increasing size of the formed cylindrical piece(s) along with formation of a hollow structure with closed ends, and thereafter followed by exposing to a temperature in the range of 100 to 180° C. until the moisture reduces to 1-5% by weight in a stage-2 drying process to cause dehydration and form the hollow snack product in form of a horseshoe tunnel with closed ends and having shape corresponding to the formed cylindrical piece(s) with rigid structure, crispy and crunchy texture and an Overall Acceptability Score of at least 7.5.

2. The process (100) as claimed in claim 1, wherein, the base ingredient is in any one form selected from a raw/unprocessed and processed, and further comprises of at least one selected from a group consisting of vegetables, fruits, millets, legumes, cereals, nuts, grains, pulses, beans, seeds and combinations thereof.

3. The process (100) as claimed in claim 2, wherein, the process (100) further comprises a processing step in an event the base ingredient is raw, wherein the processing step includes a cooking and grinding stage to obtain a puree, and wherein, starch present within the base ingredient undergoes gelatinization during the cooking stage.

4. The process (100) as claimed in claim 1, wherein the native starch is at least one selected from a group consisting of potato starch, tapioca starch, corn starch, rice starch, bean starch and combinations thereof.

5. The process (100) as claimed in claim 1, wherein the native starch is not required to be added at step (a) in an event the base ingredient contains a high amount of starch such that the starch content get maintained at the pre-defined values thereof.

6. The process (100) as claimed in claim 1, wherein the water is not required to be added at step (a) in an event the base ingredient contains a high amount of water such that the starch:water ratio get maintained at the pre-defined values thereof.

7. The process (100) as claimed in claim 5, wherein the step of gelatinization of the homogeneous mixture at step (b) is not required in an event the native starch is not added at step (a).

8. The process (100) as claimed in claim 1, optionally comprising a step of adding at least one ingredient selected from a group consisting of protein(s), protein isolate(s), protein concentrate(s), edible soluble fibre(s), edible insoluble fibre(s) such as citrus, wheat, oat fibre and combinations thereof, in the homogeneous mixture of step (a) to enhance nutritional profile of the hollow snack product.

9. The process (100) as claimed in claim 1, optionally comprising a step of adding at least one ingredient selected from a group consisting of oil, salt, sugar, yeast, flavouring agent, colouring agent, seasoning(s), spice(s), herb(s), vitamin(s), and combinations thereof, in the aerated mixture of step (c) to enhance organoleptic properties of the hollow snack product.

10. The process (100) as claimed in claim 1, wherein the mechanical aerating apparatus is selected from a group consisting of continuous mixer, food processor with dough blade, thermomix, mixing bowl with a whipping blade and a single stone and double stone grinder.

11. The process (100) as claimed in claim 1, wherein the piping apparatus includes any one of manual and automated piping apparatus, and is at least one selected from a group consisting of a cookie drop wire cut machine, a volumetric doser and a piping bag.

12. The process (100) as claimed in claim 1, wherein the at least one cylindrical shape is selected from a group consisting of a cylinder, a cylindrical curl, a cylindrical ring, a cylindrical S-shaped curve and combinations thereof.

13. The process (100) as claimed in claim 1, wherein the 2-stage drying process is performed using the at least one dryer selected from a group consisting of a conventional oven, convection oven, hot air dryer, multi-layer dryer, a vacuum dryer, a gas fired rotary oven and combinations thereof.

14. The process (100) as claimed in claim 1, wherein the hollow snack product is in form of a cylindrical tunnel with closed ends having shape corresponding to the formed cylindrical piece(s).

15. A hollow snack product comprising of 30-100% by weight of at least one base ingredient, having a moisture content in the range of 1-5% by weight, bulk density in range of 0.15 g/cc-0.3 g/cc, and dimensions as Length in the range of 20-100 mm, Breadth in the range of 6-18 mm and Height in the range of 6-18 mm, wherein, the hollow snack product is formed as a horseshoe tunnel with closed ends having at least one cylindrical shape, and wherein, the hollow snack product has a crispy and crunchy texture with an Overall Acceptability Score of at least 7.5.

16. The hollow snack product as claimed in claim 15, wherein the base ingredient is in any one form selected from a raw/unprocessed and processed, and further comprises of at least one selected from a group consisting of vegetables, fruits, millets, legumes, cereals, nuts, grains, pulses, beans, seeds and combinations thereof.

17. The hollow snack product as claimed in claim 15, further comprising of at least one native starch in a quantity depending upon starch content of the base ingredient.

18. The hollow snack product as claimed in claim 17, wherein the native starch is at least one selected from a group consisting of potato starch, tapioca starch, corn starch, rice starch, bean starch and combinations thereof.

19. The hollow snack product as claimed in claim 15, optionally comprising of at least one ingredient selected from a group consisting of protein(s), protein isolate(s), protein concentrate(s), edible soluble fibre(s), edible insoluble fibre(s), oil, salt, sugar, yeast, flavouring agent, colouring agent, seasoning(s), spice(s), herb(s), vitamin(s) and combinations thereof to enhance nutritional profile and organoleptic properties of the hollow snack product.

20. The hollow snack product as claimed in claim 15, being formed as a cylindrical tunnel with closed ends having at least one cylindrical shape, and having a diameter in the range of 6-18 mm.

21. The hollow snack product as claimed in claim 15 and claim 20, wherein, the at least one cylindrical shape is any one selected from a group consisting of a cylinder, a cylindrical curl, a cylindrical ring, a cylindrical S-shaped curve and combinations thereof.
